(19) United States
(12) Patent Application Publication
(10) Pub. No.: US 2025/0124947 A1
(43) Pub. Date: Apr. 17, 2025

(54) PROBE HEAD WITH TRAILING SHIELD FOR MAGNETIC RECORDING ON TAPE

(71) Applicant: INTERNATIONAL BUSINESS MACHINES CORPORATION, Armonk, NY (US)

(72) Inventors: Robert Fontana, San Jose, CA (US); Mark Alfred Lantz, Adliswil (CH); Hugo E. Rothuizen, OBERRIEDEN (CH)

(21) Appl. No.: 18/488,897

(22) Filed: Oct. 17, 2023

(51) Int. Cl. G11B 5/40; G11B 5/008; G11B 5/584; G11B 5/667

(52) U.S. Cl. CPC G11B 5/40; G11B 5/00813; G11B 5/48; G11B 5/584; G11B 5/667

(57) ABSTRACT

Provided are apparatus, systems and methods relating to magnetic recording on tape. A tape storage apparatus may be used that includes a probe head for writing data by perpendicular recording on a magnetic tape including a magnetic particle layer and a soft magnetic underlayer. The probe head includes a probe tip and a trailing shield adjacent to the probe tip.

### BACKGROUND OF THE INVENTION

### 1. Field of the Invention

Provided are devices and methods for magnetic recording on tape using perpendicular oriented media with a soft underlayer and a probe head with a trailing shield.

### 2. Description of the Related Art

In magnetic storage systems, data is read from and written onto magnetic recording media utilizing magnetic read and write elements formed on a tape head. Data is written on the magnetic recording media by moving a magnetic recording transducer to a position over the media where the data is to be stored. The magnetic recording transducer generates a magnetic field, which encodes the data into the magnetic media. Data is read from the media by similarly positioning the magnetic read element and then sensing the magnetic field of the magnetic media. Read and write operations may be independently synchronized with the movement of the media to ensure that the data can be read from and written to the desired location on the media.

Present magnetic tape recording systems may use particulate media with a ring head for reading and writing to the tape. Particles such as BaFe may be used with magnetization oriented in the direction perpendicular to the surface of the tape. The orientation results from a combination of the application of a magnetic field during the coating process and a preference of the particles to orient parallel to the surface of the tape substrate. The ring head produces an external magnetic field, confined in the region around the write gap of the head, that orients the magnetization of the particles. The perpendicular component of the external magnetic field acts to orient or switch the magnetization of the media grains to write to the media.

### SUMMARY

Provided is a storage apparatus comprising a probe head for writing data by perpendicular recording on a magnetic tape including a magnetic particle layer and a soft magnetic underlayer, the probe head including a probe tip and a trailing shield adjacent to the probe tip.

Also provided is a tape storage system including a probe head for writing data by perpendicular recording on a magnetic tape, the probe head including a probe tip and a trailing shield positioned in close proximity to the probe tip. The system also includes a tape transport mechanism for transporting the magnetic tape past the probe head, and a supply of the magnetic tape, the magnetic tape comprising a magnetic particle layer and a soft magnetic underlayer positioned on a substrate.

Also provided is a method for writing data to magnetic tape using a tape storage apparatus. The method includes providing a probe tip configured to perpendicularly write data to tracks on a magnetic tape including a magnetic particle layer and a soft magnetic underlayer. The method also includes positioning a return pole spaced apart from the probe tip. A trailing shield is positioned in close proximity to the probe tip. The method further includes performing write operations on data tracks including shingling to narrow the tracks of written data, wherein the trailing shield is positioned to inhibit track edge distortion during the shingling.

### BRIEF DESCRIPTION OF THE DRAWINGS

FIG. 1 illustrates a schematic of perpendicular recording on magnetic tape using an apparatus in accordance with certain embodiments.

FIG. 2 illustrates features of the apparatus of FIG. 1 in accordance with certain embodiments.

FIG. 3 a view of a probe tip and trailing shield in accordance with certain embodiments.

FIG. 4 illustrates a flowchart of operations in accordance with certain embodiments.

### DETAILED DESCRIPTION

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The description herein provides examples of embodiments of the invention, and variations and substitutions may be made in other embodiments. Several examples will now be provided to further clarify various embodiments of the present disclosure:

Example 1: A tape storage apparatus comprising a probe head for writing data by perpendicular recording on a magnetic tape including a magnetic particle layer and a soft magnetic underlayer, the probe head including a probe tip and a trailing shield adjacent to the probe tip. By providing a trailing shield adjacent to the probe tip, shingled tracks having a narrow width may be written to the magnetic tape. The trailing shield acts to confine the magnetic fields to the region of the probe tip, providing well defined bit edges.

Example 2: The limitations of any of Examples 1 and 3-7, wherein the probe tip includes a leading edge, a trailing edge, and sidewalls, wherein the sidewalls are oriented at a right angle to the leading edge. Providing sidewalls oriented at a right angle may lead to more narrow shingling of tracks and enable easier fabrication.

Example 3: The limitations of any of Examples 1-2 and 4-7, wherein the trailing shield is configured so that the trailing edge of the probe tip is spaced apart from the trailing shield a distance in the range of 20 nm to 50 nm. Such spacing enables the trailing shield to suppress the fringing fields and enables better shingling of tracks and improved narrow track write performance.

Example 4: The limitations of any of Examples 1-3 and 5-7, wherein the sidewalls of the probe tip are spaced apart from the trailing shield a distance in the range of 20 nm to 50 nm. Such positioning of the trailing shield enables additional shielding of the sidewalls of the probe tip during writing operations.

Example 5: The limitations of any of Examples 1-4 and 6-7, wherein the trailing shield has a thickness in the range of 50 nm to 500 nm. The trailing shield acts to confine the magnetic fields to the region of the probe tip, providing well defined bit edges.

Example 6: The limitations of any of Examples 1-5 and 7, wherein the trailing shield covers the sidewalls and trailing edge, and wherein the trailing shield has a length in the range of 50 nm to 2000 nm. The trailing shield effectively reduces side fringe fields during shingling operations.

Example 7: The limitations of any of Examples 1-6, wherein the probe tip includes an end surface that is rectangular in shape. The shape contributes to providing fields that have primarily large perpendicular field components with small longitudinal components in the vicinity of the recording layer. The shape of the tip can also enable ease of fabrication.

Example 8: A tape storage system comprising a probe head for writing data by perpendicular recording on a magnetic tape, the probe head including a probe tip and a trailing shield positioned in close proximity to the probe tip. The tape storage system also includes a tape transport mechanism for transporting the magnetic tape past the probe head, and a supply of the magnetic tape, the magnetic tape comprising a magnetic particle layer and a soft magnetic underlayer positioned on a substrate. By providing a trailing shield adjacent to the probe tip, shingled tracks having a narrow width may be written to the magnetic tape. The trailing shield acts to confine the magnetic fields to the region of the probe tip, providing well defined bit edges.

Example 9: The limitations of any of Examples 8 and 10-17, wherein the probe tip includes a leading edge, a trailing edge, and sidewalls, wherein the sidewalls are oriented at a right angle to the leading edge. Providing sidewalls oriented at a right angle may lead to more narrow shingling of tracks and enable easier fabrication.

Example 10: The limitations of any of Examples 8-9 and 11-17, wherein the trailing shield is configured so that the trailing edge of the probe tip is spaced apart from the trailing shield a distance in the range of 20 nm to 50 nm. Such spacing enables the trailing shield to suppress the fringing fields and enables better shingling of tracks and improved narrow track write performance.

Example 11: The limitations of any of Examples 8-10 and 12-17, wherein the sidewalls of the probe tip are spaced apart from the trailing shield a distance in the range of 20 nm to 50 nm. Such positioning of the trailing shield enables additional shielding of the sidewalls of the probe tip during writing operations.

Example 12: The limitations of any of Examples 8-11 and 13-17, wherein the trailing shield has a thickness in the range of 50 nm to 500 nm. The trailing shield acts to confine the magnetic fields to the region of the probe tip, providing well defined bit edges.

Example 13: The limitations of any of Examples 8-12 and 14-17, wherein the trailing shield covers the trailing edge and the sidewalls of the probe tip, and wherein the trailing shield has a length in the range of 50 nm to 2000 nm. The trailing shield effectively reduces side fringe fields during shingling operations.

Example 14: The limitations of any of Examples 8-13 and 15-17, wherein the probe tip includes an end surface that is rectangular in shape. The shape contributes to providing fields that have primarily large perpendicular field components with small longitudinal components in the vicinity of the recording layer. The shape of the tip can also enable ease of fabrication.

Example 15: The limitations of any of Examples 8-14 and 16-17, wherein the tape transport mechanism transports the magnetic tape in a direction of travel from the leading edge to the trailing edge of the probe tip, and wherein the sidewalls of the probe tip are parallel to the direction of travel. The shape of the sidewalls allows for more precise processing of the pole structure, which can lead to shingling tracks with more narrow dimensions.

Example 16: The limitations of any of Examples 8-15 and 17, wherein the probe tip operates to provide shingled tracks on the tape having a width of no greater than 500 nm. Providing shingled tracks with such a width enables improved recording density on the tape.

Example 17: The limitations of any of Examples 8-16, wherein the probe tip operates to provide shingled tracks on the tape having a width of no greater than 250 nm. Providing shingled tracks with such a width enables improved recording density on the tape.

Example 18: A method for writing data to magnetic tape using a tape storage apparatus, comprising providing a probe tip configured to perpendicularly write data to tracks on a magnetic tape including a magnetic particle layer and a soft magnetic underlayer. The method also includes positioning a return pole spaced apart from the probe tip, and positioning a trailing shield in close proximity to the probe tip. The method also includes performing write operations on data tracks including shingling to narrow the tracks of written data, wherein the trailing shield is positioned to inhibit data track edge distortion during the shingling. By providing a trailing shield adjacent to the probe tip, shingled tracks having a narrow width may be written to the magnetic tape. The trailing shield acts to confine the magnetic fields to the region of the probe tip, providing well defined bit edges.

Example 19: The limitations of any of Examples 18 and 20, further comprising positioning the trailing shield a distance away from the probe tip a distance in the range of 20 nm to 50 nm. Such spacing enables the trailing shield to suppress the fringing fields and enables better shingling of tracks and improved narrow track write performance.

Example 20: The limitations of any of Examples 18-19, further comprising configuring the probe tip to include a leading edge, a trailing edge, and sidewalls, wherein the sidewalls are oriented at a right angle to the leading edge. Providing sidewalls oriented at a right angle may lead to more narrow shingling of tracks and enable easier fabrication.

Embodiments include a perpendicular recording system using a perpendicular oriented tape media with a soft underlayer, and a probe head with a trailing shield. Such a configuration enables the ability to write and subsequently shingle narrow tracks of recording information at higher densities, with substantially smaller track widths than that which can be obtained using conventional ring heads.

Associated with the write fields from a ring head are side or fringing fields. These fringing fields act to distort the edges of the written bits during the shingling operation of the tape recording process. Shingling is the overlapping of adjacent tracks on the tape, which results in narrower tracks and thus greater areal density. By distorting the edges of the written bits during tape writing, the fringing fields limit the dimension of the final written bit width. In a ring write head the lateral extent of the fringing field is on the order the write gap between poles. For a ring head to generate a sufficient perpendicular component for the write field, the write gap in a ring head may be about 100-120 nm (nanometers). Where the lateral extent of the perpendicular component of the write field is 100 nm, when the tracks are shingled to a final dimension of, for example 500 nm, the extent of the track edge distortion caused by the fringing fields will be about 20% of the total track width (100 nm/500 nm). As track widths become more narrow, the extent of track edge distortion caused by the fringing fields will increase substantially. For example, moving to track widths in the 250 nm range will have track edge distortion on the order of 40%, making the recording detection (i.e. the signal to noise ratio) inadequate.

In accordance with certain embodiments, advantages can be obtained using a perpendicular recording system that includes perpendicular oriented tape media with a soft underlayer and a probe head with a trailing shield. Such advantages may include the ability to write and subsequently shingle narrow tracks of recorded information at higher densities. This is because the use of the probe head and the soft underlayer results in larger components of perpendicular magnetic field switching the grains and unlike the ring head (where the lateral extent of the fringing field is on the order of the write gap thickness), for a probe head the fringing field is on the order of the separation between the probe head and the trailing shield. Such a separation is substantially less than that used in a ring head. The minimum trailing shield separation is limited so that excess write field is not shunted into the trailing shield.

Separations between the perpendicular oriented probe head and the trailing shield may in certain embodiments be about 30 nm or about 4 times less than the write gaps in a longitudinal write head or ring head. In addition, the lateral extent or thickness of the trailing shield may be controlled to a dimension on the order of about 50 to 500 nm, for ease of fabrication. In certain embodiments the thickness may be about 100 nm. Since the trailing shield separations in a probe head may be about 4 times smaller than the write gap in a ring head, side writing or shingling will be improved for a tape system with perpendicular media and a probe head. Certain embodiments provide shingled tracks on tape having a width of 500 nm or less. Other embodiments provide shingled tracks having a width of 250 nm or less. Using a probe head and trailing shield, shingled tracks with a 250 nm width will have a potential distortion over a distance of about 30 nm. This equates to a distortion of 12% versus 40% for a ring head.

Furthermore, in tape applications, in certain embodiments the geometry of the probe structure at the tape bearing surface has advantages due to the shape of the side walls. Since tape may use a linear actuator, the side walls of the probe tip may be straight. Such a straight structure allows for more precise processing of the width of the poles. As a result, the probe head can shingle tracks to substantially narrower dimensions than a ring head.

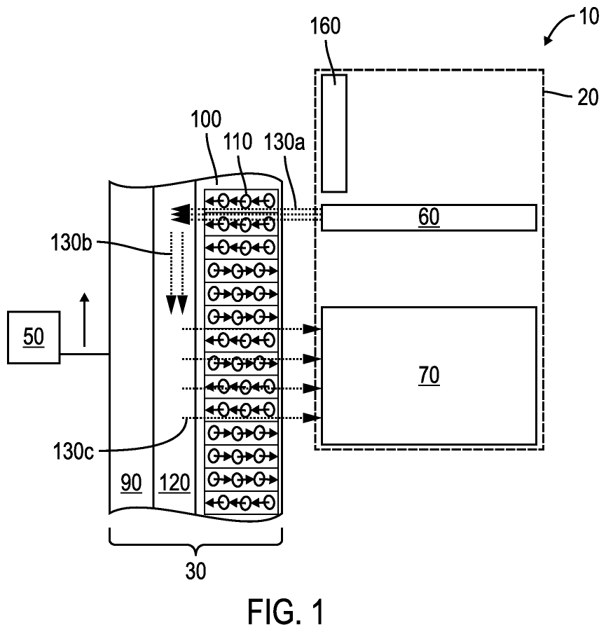

FIG. 1 schematically illustrates a view in cross section that shows operation of a tape storage apparatus in accordance with certain embodiments for perpendicular recording on magnetic tape. The apparatus 10 may include a read/write head which includes at least one probe head 20 for writing data on a reel of magnetic tape 30. In practice, the read/write head of apparatus 10 may include one or more write modules each including multiple probe heads 20 for writing data in respective tracks of the tape 30. For example, a typical read/write head may comprise two write modules, each with multiple (e.g., 32) probe heads (plus servo elements for tracking), and a read module with multiple read heads (not shown) for readback of data from the tape tracks.

The tape reel may be housed in a cartridge/cassette (not shown) which is loaded and presented to the head for read/write operations. The storage apparatus 10 may include a library of tape cartridges which can be selected and loaded automatically to one or more drives as is well known in the art, where each drive includes a read/write head as described above. During read/write operations, a tape transport mechanism, indicated schematically at 50, operates to transport the tape 30 past the head in a generally known manner. As seen in FIG. 1, the tape 30 may move in the direction of the arrow adjacent to the tape transport mechanism 50 (bottom to top in FIG. 1).

In certain embodiments the probe head 20 may include a high moment monopole pole tip 60 (also referred to as probe tip) and a return pole 70 for writing data by perpendicular recording on the tape 30. The tape 30 includes a tape substrate 90 and a perpendicular magnetic recording layer 100 disposed over the substrate 90. The recording layer 100 includes magnetic particles 110 suspended in a binder material. The magnetic particles 110 may include suitable particles such as one of barium ferrite, strontium ferrite, epsilon iron oxide and chromium dioxide. The binder material may be any suitable material, for example, some form of polymer. The particulate magnetic recording layer 100 can be produced using known techniques for forming particulate recording layers in magnetic tape. As indicated schematically by the arrows on the magnetic particles 110 in FIG. 1, the axis of easy magnetization of the magnetic particles is orientated substantially perpendicular to the surface of tape 30.

The tape 30 further includes a soft-magnetic underlayer 120 which is disposed between recording layer 100 and the tape substrate 90. The soft magnetic underlayer 120 may include at least one layer of a suitable magnetically soft material as known in the art. The magnetically soft layer may be formed over the substrate 90 by, for example, one of a sputtering and an evaporation process, thereby producing a continuous (non-particulate) thin film of magnetically soft material on the substrate 90. The substrate 90 may be formed from a suitable material as known in the art such as, for example, a polymer. In certain embodiments the particulate recording layer 100 may have a thickness in the range of from about 10 nm to about 70 nm, and the soft magnetic underlayer 120 may have a thickness in the range of about 20 nm to about 200 nm. The tape substrate 90 is typically less than 5 microns thick.

In a write operation, magnetic flux from the tip 60 passes through the tape medium as indicated schematically by the dotted line arrows 130a. Flux emanating from the tip 60 is substantially perpendicular to the recording layer, whereby the particles in the recording layer 100 are orientated to write a “1” or “0” depending on the direction of the applied field, as indicated by the arrows extending through the particles 110. The soft magnetic underlayer 120 provides a return path for the magnetic field to return pole 70 of the write-head. As shown in FIG. 1, the return path travels along the soft magnetic underlayer 120 as indicated by the dotted line arrows 130b and then through the recording layer 100 to the probe head return pole 70 as indicated by the dotted line arrows 130c.

The trailing shield 160 is positioned in close proximity to the probe tip 60, with separation between the perpendicular oriented probe tip 60 and the trailing shield in certain embodiments being about 30 nm. In addition, the thickness of the trailing shield 160 may be controlled to conduct excess write field away from the probe field. The trailing shield may be formed from a suitable magnetically conductive material, for example, a ferromagnetic material.

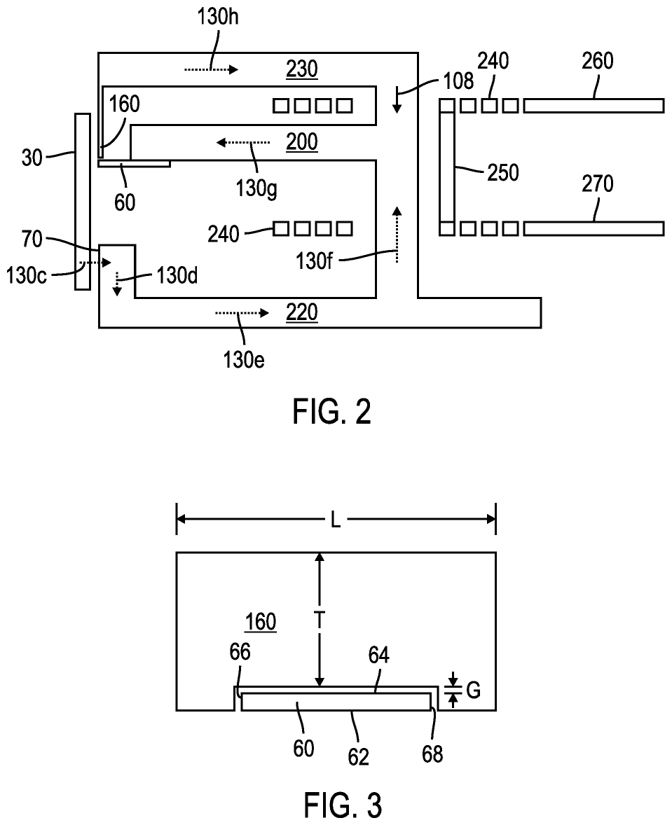

FIG. 2 illustrates additional features of the probe head 20 in a cross sectional view. The probe tip 60 extends from the main yoke 200 and delivers the magnetic flux to the tape 30. The flux path travels through the tape 30 to return pole 70 and through the return yoke 220 so that the flux path travels out from the tape 30 and back towards the main yoke 200, as indicated by the dotted line arrows 130d, 130e, 130f, 130g. A magnetic field pathway may also flow from the shield through yoke portion 230 back towards the main yoke 200, as indicated by the dotted line arrows 130h, 130i. Magnetizing coil 240 is also present above and below the main yoke 200. The coil 240 may comprise pancake coils having two coil layers. The vertical bar 250 is an electrical connection between windings, and the horizontal bars 260, 270 are wiring connections.

FIG. 3 illustrates a tape bearing surface view of the probe tip 60 and trailing shield 160 looking upward from the tape 30 surface. The probe tip 60 may be substantially rectangular in shape and include straight walls. Providing straight walls enables more precise processing of the width of the poles. The probe tip 60 includes a leading edge 62, a trailing edge 64, and sidewalls 66, 68 wherein the sidewalls 66, 68 are oriented at a right angle to the leading edge 62. The views of the probe tip 60 and shield 160 in FIGS. 1-2 correspond to a cross section extending through the shield, the trailing edge 64, and the leading edge 62 of the probe tip 60 illustrated in FIG. 3. The shield 160 may be configured so that the sidewalls 66, 68 and trailing edge 64 of the probe tip 20 are covered (shielded) by the shield 160. The sides of the shield 160 may extend parallel to the sidewalls 66, 68 of the probe tip 60 as seen in FIG. 3, in order to provide additional shielding.

Shielding the sidewalls 66, 68 acts to suppress the fringing fields and enables better shingling. The separation gap between the trailing shield 160 and the probe tip 60 determines the extent of the fringing field. In certain embodiments a separation gap G may be about 20 nm to about 50 nm. In addition, in certain embodiments the lateral thickness T of the trailing shield 160 may include a range of about 50 nm to about 500 nm. In certain embodiments the longitudinal dimension L of the trailing shield 160 may be about 50 nm to about 2000 nm.

Structures as described above permit improved narrow track write performance. The probe head 20 produces a stronger and more perpendicularly oriented write field relative to a conventional ring head. The trailing shield 160 effectively reduces side fringe fields and as a result minimizes distortion of the edges of written bits during shingling operation. The soft magnetic underlayer 120 provides a flux conduction path for the fields from the probe head 20, allowing the write field to penetrate the media and maintain spatial confinement through the media. The writing process is more spatially localized than the write process for a conventional ring head due to the presence of the soft magnetic underlayer 120, the trailing shield 160 structure, and the probe head 20 shape configuration that provides fields that have primarily large perpendicular field components with small longitudinal components in the vicinity of the recording layer. The presence of the trailing shield 160 acts to confine the magnetic fields to the region of the probe tip, providing well defined bit edges.

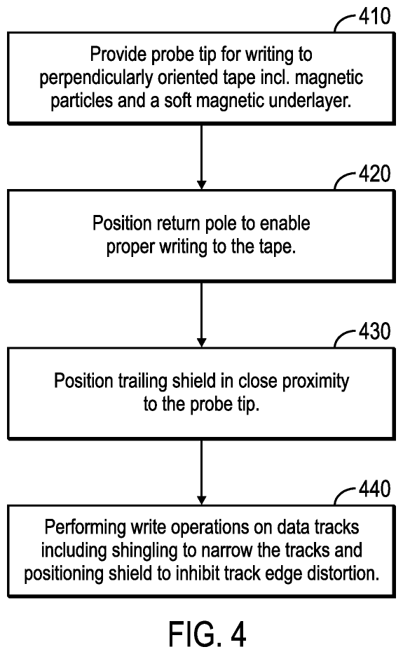

Embodiments also relate to methods for writing data to magnetic tape. FIG. 4 is a flowchart of operations in accordance with certain embodiments. Some of the operations have been discussed above in connection with embodiments illustrated in other figures. Block 410 is providing a probe tip configured to direct a magnetic field into a perpendicularly oriented media including a layer of magnetic particles and a soft magnetic underlayer in order to write data onto the media. The probe tip may have an end with a rectangular shape and straight sidewalls extending from the leading edge to the trailing edge. Block 420 is positioning a return pole a suitable distance away from the probe tip in order to enable proper writing to the tape. Block 430 is positioning a trailing shield in close proximity to the pole tip. The trailing shield may be configured to cover side surfaces of the probe tip to limit side fringing fields during writing operations. Block 440 is performing write operations on data tracks and performing shingling to narrow the tracks of written data, where the trailing shield is positioned to inhibit track edge distortion during the shingling.

It will be appreciated that various other changes and modifications can be made to the particular embodiments described. In general, where features are described herein with reference to a magnetic tape embodying the invention, corresponding features may also be provided in various methods and in various devices such as tape storage devices embodying the invention.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the described embodiments, any variables i, n, etc., when used with different elements may denote a same or different instance of that element.

Terms such as “an embodiment”, “embodiment”, “embodiments”, “the embodiment”, “the embodiments”, “one or more embodiments”, “some embodiments”, “certain embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices/articles. The functionality and/or the features of a device may be alternatively embodied by one or more other devices which are not explicitly described as having such functionality/features. Thus, other embodiments of the present invention need not include the device itself.

Aspects of the present invention are described herein with reference to flowchart illustrations and/or block diagrams according to embodiments of the invention. Individual blocks may be optional, and the order of blocks may be varied. Inventive subject matter may be found in each block individually or in groups of the blocks. It will be understood that each block of the flowchart illustrations and/or block diagrams, and combinations of blocks in the flowchart illustrations and/or block diagrams, can be implemented by a machine system to manufacture and implement embodiments as described herein.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed:

1. A tape storage apparatus comprising a probe head for writing data by perpendicular recording on a magnetic tape including a magnetic particle layer and a soft magnetic underlayer, the probe head including a probe tip and a trailing shield adjacent to the probe tip.

2. The tape storage apparatus of claim 1, wherein the probe tip includes a leading edge, a trailing edge, and sidewalls, wherein the sidewalls are oriented at a right angle to the leading edge.

3. The tape storage apparatus of claim 2, wherein the trailing shield is configured so that the trailing edge of the probe tip is spaced apart from the trailing shield a distance in the range of 20 nm to 50 nm.

4. The tape storage apparatus of claim 3, wherein the sidewalls of the probe tip are spaced apart from the trailing shield a distance in the range of 20 nm to 50 nm.

5. The tape storage apparatus of claim 1, wherein the trailing shield has a thickness in the range of 50 nm to 500 nm.

6. The tape storage apparatus of claim 2, wherein the trailing shield covers the sidewalls and trailing edge, and wherein the trailing shield has a length in the range of 50 nm to 2000 nm.

7. The tape storage apparatus of claim 1, wherein the probe tip includes an end surface that is rectangular in shape.

8. A tape storage system comprising:
a probe head for writing data by perpendicular recording on a magnetic tape, the probe head including a probe tip and a trailing shield positioned in close proximity to the probe tip;
a tape transport mechanism for transporting the magnetic tape past the probe head; and
a supply of the magnetic tape, the magnetic tape comprising a magnetic particle layer and a soft magnetic underlayer positioned on a substrate.

9. The tape storage system of claim 8, wherein the probe tip includes a leading edge, a trailing edge, and sidewalls, wherein the sidewalls are oriented at a right angle to the leading edge.

10. The tape storage system of claim 9, wherein the trailing shield is configured so that the trailing edge of the probe tip is spaced apart from the trailing shield a distance in the range of 20 nm to 50 nm.

11. The tape storage system of claim 10, wherein the sidewalls of the probe tip are spaced apart from the trailing shield a distance in the range of 20 nm to 50 nm.

12. The tape storage system of claim 8, wherein the trailing shield has a thickness in the range of 50 nm to 500 nm.

13. The tape storage system of claim 9, wherein the trailing shield covers the trailing edge and the sidewalls of the probe tip, and wherein the trailing shield has a length in the range of 50 nm to 2000 nm.

14. The tape storage system of claim 8, wherein the probe tip includes an end surface that is rectangular in shape.

15. The tape storage system of claim 9, wherein the tape transport mechanism transports the magnetic tape in a direction of travel from the leading edge to the trailing edge of the probe tip, and wherein the sidewalls of the probe tip are parallel to the direction of travel.

16. The tape storage system of claim 8, wherein the probe tip operates to provide shingled tracks on the tape having a width of no greater than 500 nm.

17. The tape storage system of claim 16, wherein the probe tip operates to provide shingled tracks on the tape having a width of no greater than 250 nm.

18. A method for writing data to magnetic tape using a tape storage apparatus, comprising:
providing a probe tip configured to perpendicularly write data to tracks on a magnetic tape including a magnetic particle layer and a soft magnetic underlayer;
positioning a return pole spaced apart from the probe tip;
positioning a trailing shield in close proximity to the probe tip; and
performing write operations on data tracks including shingling to narrow the tracks of written data, wherein the trailing shield is positioned to inhibit data track edge distortion during the shingling.

19. The method of claim 18, further comprising positioning the trailing shield a distance away from the probe tip a distance in the range of 20 nm to 50 nm.

20. The method of claim 18, further comprising configuring the probe tip to include a leading edge, a trailing edge, and sidewalls, wherein the sidewalls are oriented at a right angle to the leading edge.
